(19) United States
(12) Patent Application Publication
(10) Pub. No.: US 2008/0241322 A1
(43) Pub. Date: Oct. 2, 2008

(54) PROCESS AND APPARATUS FOR MAKING CAFFE LATTE MACCHIATO

(75) Inventor: Rainer Bunge, Zurich (CH)

Correspondence Address: PEPPER HAMILTON LLP, ONE MELLON CENTER, 50TH FLOOR, 500 GRANT STREET, PITTSBURGH, PA, 15219, US

(73) Assignee: NIRO-PLAN AG, Aarburg (CH)

(21) Appl. No.: 12/061,173

(22) Filed: Apr. 2, 2008

(30) Foreign Application Priority Data
Apr. 2, 2007 (DE) 10 2007 017 450.2

(51) Int. Cl. A23L 1/025; A47J 31/24

(52) U.S. Cl. 426/238; 99/279; 99/451

(57) ABSTRACT

A process for making caffe latte macchiato from coffee, milk and frothy milk, may include loading at least part of the frothy milk with oscillations in the ultrasonic range before the addition of coffee. An apparatus for making caffe latte macchiato from coffee, milk and frothy milk, may include a coffee unit that is used to supply coffee, a milk unit that is used to supply at least a frothy milk, and a mechanism for loading the frothy milk with oscillations.

### CROSS-REFERENCE TO RELATED APPLICATIONS

This patent application claims priority to German Patent Application No. 10 2007 017 450.2, filed Apr. 2, 2007, titled “Verfahren und Vorrichtung zur Herstellung von Caffe Latte Macchiato.”

### STATEMENT REGARDING FEDERALLY SPONSORED RESEARCH

Not applicable.

### NAMES OF PARTIES TO A JOINT RESEARCH AGREEMENT

Not applicable.

### SEQUENCE LISTING

Not applicable.

### BACKGROUND

1. Technical Field

The invention relates to the area of making hot beverages. Specifically, the process and the apparatus serve to make caffe latte macchiato (CLM).

2. Description of the Related Art

CLM is a hot beverage based on milk and coffee. It is distinguished in that the components milk, coffee and frothy milk are arranged from the bottom up in three defined, superposed layers. In the making of CLM, at first milk is placed in the drinking container, then frothy milk is placed on top of it, and then the coffee is added. If the correct method of preparation was used, the coffee seeps through the froth layer and spreads out on the milk/froth boundary surface without mixing with the milk. This forms a sharp boundary surface between the coffee and the milk.

The making of CLM requires a subtle coordination in particular of the following parameters: milk fat content, milk protein content, milk temperature, coffee temperature, coffee bean type, water hardness, type of mechanical stressing during the frothing, thickness of the froth layer, consistency of the froth layer, height of fall of the coffee, sequence in time of the process steps, and all pauses between these steps. These parameters are not independent of each other but rather are linked to each other in a complicated manner.

Whereas a coordination of the above-cited influencing variables on the individual properties of water, milk and coffee takes place in a more or less intuitive manner during the manual making of CLM by an experienced consumer and therefore a satisfactory result can be achieved as a rule, this is not possible when making CLM with machines, in particular completely automatic coffee machines. It is expected from such a machine that it functions robustly and reliably regardless of variable properties of the materials used and the structural conditions. The commercially available machines meet this criterion only unsatisfactorily. Instead of a sharp boundary layer, the coffee forms a continuous transition to the milk underneath it, producing so-called “coffee streaks” in the milk. Whereas machines that are new from the factory usually make an acceptable CLM available, this is frequently no longer the case in particular for machines that have already been used for some time. The reasons for this are for the most part unclear.

It is known to an expert in the art that a pause between the adding of the froth and the subsequent adding of the coffee can considerably improve the results. In a manual preparation of CLM, this pause is typically between 10 and 30 seconds. However, there is no suggestion in the literature of why this pause is important. Therefore, purely empirical knowledge is involved.

Such a waiting period is also typical in CLM machines. However, there is an optimization conflict here in particular in the area of professional CLM machines. The longer the pause lasts, the better the result, but the customer does not want to wait long for his beverage.

The invention has the basic problem of creating a process and an apparatus that permit the making of a high-quality CLM in a short time, that is, without a significant pause being necessary between the addition of froth and the addition of coffee.

This problem is solved by the process and the apparatus as they are defined in the patent claims. According to the process of the invention, the milk froth is loaded for a few seconds with oscillations in the ultrasonic range.

The disclosure contained herein describes attempts to address one or more of the problems described above.

### SUMMARY

In an embodiment, a process for making caffe latte macchiato may include supplying coffee, milk, and frothy milk; and loading at least part of the frothy milk with oscillations in the ultrasonic range before the addition of coffee. In an embodiment, the oscillations may be in a frequency range between 1 Hz and 1 GHz. In another embodiment, the oscillations may be in a frequency range between 100 Hz and 100 kHz.

In one embodiment of a process for making caffe latte macchiato may include loading the frothy milk with oscillations in a receiving container. In an embodiment, the receiving container may include a drinking vessel.

Yet another embodiment may include pouring the liquid milk and the frothy milk from a receiving vessel into a drinking vessel after the loading of the frothy milk with oscillations, and supplying coffee to the drinking vessel.

In an embodiment, the step of loading with oscillations in the receiving container may take place in a batch operation. In yet another embodiment, the loading with oscillations may take place in the receiving container in a continuous operation.

In an exemplary embodiment, the loading with oscillations may take place between 0.5 seconds and 20 seconds. In yet another embodiment, the loading with oscillations may take place between 1 second and 6 seconds.

Another embodiment includes an apparatus for making caffe latte macchiato. In an embodiment, an apparatus may include a coffee unit that is used to supply coffee, a milk unit that is used to supply at least frothy milk, and a mechanism for loading the frothy milk with oscillations.

In an embodiment, the mechanism for loading the frothy milk with oscillations may load the frothy milk in the ultrasonic frequency range. In one embodiment, the mechanism for loading the frothy milk with oscillations may be controlled so that the oscillations are in a range between 1 Hz and 1 GHz. In another embodiment, the mechanism for loading the frothy milk with oscillations may be controlled so that the oscillations are in a range between 100 Hz and 100 kHz.

In an embodiment, the mechanism for loading the frothy milk with oscillations may load the frothy milk in a contactless manner. In another embodiment, the mechanism for loading the frothy milk with oscillations may be coupled to a container receiving the frothy milk. In still another embodiment, the mechanism for loading the frothy milk with oscillations may include an ultrasonic bath. In an embodiment, the mechanism for loading the frothy milk with oscillations may include an ultrasonic exciter.

A process for making caffe latte macchiato may include supplying a coffee, a milk, and frothy milk, and applying an ultrasonic exciter to at least part of the frothy milk before the addition of coffee. In an embodiment, the ultrasonic exciter may apply an ultrasonic oscillation in a frequency range between 1 Hz and 1 GHz, and applying the ultrasonic exciter may take place between 0.5 seconds and 20 seconds.

### BRIEF DESCRIPTION OF THE DRAWINGS

FIG. 1a shows the state in which a mixture of frothy milk and liquid milk is filled into container when frothing milk where the ultrasonic exciter is inactive.

FIG. 1b schematically indicates the beginning of the loading of the mixture of frothy milk and milk with ultrasound by an ultrasonic exciter.

FIG. 1c shows the result after an ultrasonic excitation of approximately 5 seconds.

FIG. 2 depicts the boundary layer had formed between the milk and the frothy milk after 5 seconds of settling time.

FIG. 3 is a plot showing the time in the ultrasonic bath was recorded on the x-axis, with y-axis showing the height of the milk layer relative to the maximal height of the milk layer (complete separation of milk and frothy milk).

FIG. 4 shows the compares the results of using ultrasound with those of not using ultrasound to determine when a barrier layer forms.

FIG. 5 depicts illustrations of the reduced settling time required to form a clear boundary layer between milk and coffee when using ultrasound as compared without using ultrasound.

### DETAILED DESCRIPTION

Before the present methods, systems, and materials are described, it is to be understood that this disclosure is not limited to the particular methodologies, systems, and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

The tests of the applicant have shown in a completely surprising manner that the waiting time between the addition of froth and the addition of coffee can be drastically shortened by exposing the froth to ultrasound.

Experiments in this regard have shown that in the conventional making of froth regardless of the optical impression—the “froth” does not consist of only frothy milk, but rather that it also contains amounts of non-frothed milk (“wet” froth). Following the convention customary in the art, in this text the concepts “froth” or “milk froth” are used not only in the narrower scientific sense but also as a designation for a froth/milk mixture. This definition also concerns the patent claims in particular.

If this mixture of froth and hot milk is put on the milk in the receiving container, no pure boundary surface forms but rather a continuous transition between milk and froth. The froth and the milk successively un-mix only if this mixture is allowed to stand for, e.g., 20 seconds. The froth “dewaters” in this case in that the milk runs off downward, and at the same time air bubbles in the milk rise.

Only then does the sharp boundary surface between froth and milk form that is necessary for a good CLM. This un-mixing procedure is very heavily influenced by the exposure to ultrasound.

The process in accordance with the invention is distinguished in particular in that the waiting time between the addition of froth and the addition of coffee and therewith the making time for the CLM are greatly reduced by the ultrasound treatment.

It is sufficient according to the invention if the loading of the frothy milk with oscillations takes place for a few seconds, approximately between 0.5 seconds and 20 seconds and especially between 1 second and 6 seconds. A rather long exposure to ultrasound, that is, a loading with oscillations, does have the result of increasing the effect in that the milk separates even more completely from the frothy milk. However, tests to be described in detail in the following have shown that the creation of a first boundary layer between milk and frothy milk is already sufficient for obtaining the desired optimal results in the making of a latte macchiato coffee, namely, a beverage that includes three layers that can be distinctly distinguished from each other. These layers include liquid milk in the lower area, coffee above it with at the most only a very small amount of milk, and frothy milk floating above it.

The oscillations can have frequencies between 1 Hz and 1 GHz; however, it is preferable that the oscillations have between 100 Hz and 100 kHz and are thus totally within the ultrasonic range. These oscillations can be transmitted without problems from an exciter in the direction of the frothy milk without containers or housing walls, etc. adversely affecting the quality of the excitation of the oscillations to a substantial degree.

Thus, the loading of the frothy milk with oscillations can take place in a separate container, especially in a receiving container that can also be, e.g., the drinking container. However, the loading can also take place in a separate receiving container, e.g., inside a milk unit of a coffee machine, from which the milk and the frothy milk deposited from it, are then placed in a drinking container.

The loading can also take place in a continuous operation or also in a batch operation.

As concerns the form of the loading with oscillations, the frothy milk can either be exposed to the ultrasonic oscillations in a contactless manner or the container receiving the frothy milk can be coupled to the ultrasonic exciter and transmit the oscillations to the frothy milk in this manner. If, for example, an ultrasonic bath is used as an ultrasonic exciter, as was used in the test construction, the immersion depth of the container receiving the frothy milk can in the ultrasonic bath naturally also plays a part. Even the intensity of the ultrasonic oscillations can influence the result.

In addition to the process for making caffe latte macchiato, the present invention also makes an apparatus available for making caffe latte macchiato for solving the initially presented problem. This apparatus consists of a coffee unit and a milk unit which coffee unit is used to supply coffee and which milk unit is used to supply at least frothy milk. According to the invention, the apparatus for making caffe latte macchiato includes above all means for loading the frothy milk with oscillations. In order to separate the milk from the frothy milk in the desired manner, the means for loading the frothy milk with oscillations is capable of emitting oscillations in the ultrasonic frequency range and of loading the frothy milk with them. The means for loading the frothy milk with oscillations can be controlled in such a manner that the oscillations are in a range of 1 Hz and 1 GHz and preferably between 100 Hz and 100 kHz.

The means for loading the frothy milk with oscillations can load the frothy milk, e.g., in a contactless manner or can be coupled to a container receiving the frothy milk so that it mechanically loads the container with oscillations and the container transmits the oscillations to the frothy milk. The container does not absolutely have to be a vessel in which the frothy milk is resting but the frothy milk can theoretically be exposed to the ultrasonic oscillations when flowing through a line section.

It is especially advantageous if the frothy milk is received in a separate receiving container, loaded there by the ultrasonic oscillations, and can subsequently be put in the drinking vessel, where it is then loaded by coffee supplied from the coffee unit. This ensures that the ultrasonic excitation always takes place under the same prerequisites in the calibrated receiving container and is not dependent, e.g., on the particular individual cup size, cup thickness, etc.

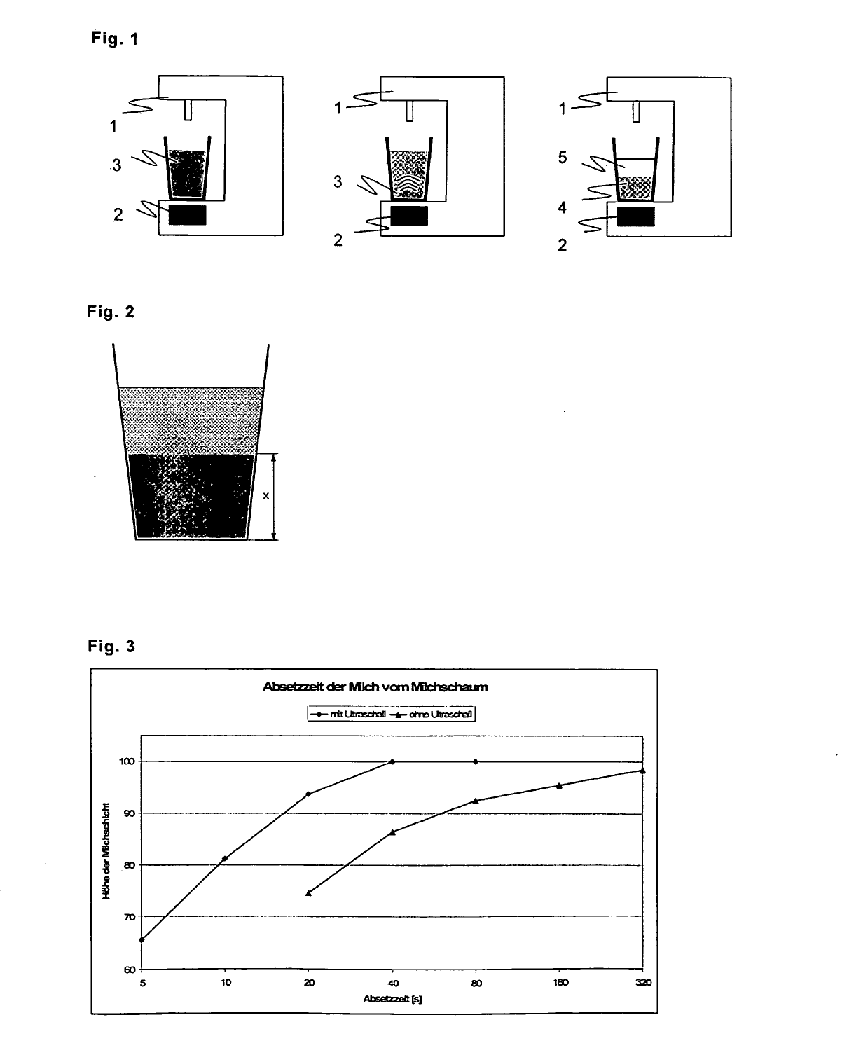

Other features and advantages of the present invention result from the following description of an exemplary embodiment using the drawings, that schematically show in FIG. 1 the three most important phases in the loading of frothy milk with ultrasound. A test series and its results are also subsequently documented.

FIGS. 1a-1c show an apparatus 1 in accordance with the invention for making caffe latte macchiato in three schematic side views in FIGS. 1a, 1b and 1c that correspond to each other. An essential component of apparatus 1 is an ultrasonic exciter 2 serving as means for loading frothy milk with oscillations and arranged in the exemplary embodiment in the lower area of the apparatus. A container 3 is provided above ultrasonic exciter 2 that serves to receive frothy milk in particular during the loading with oscillations.

FIG. 1a shows the state in which a mixture of frothy milk and liquid milk is filled into container 3, as regularly occurs when frothing milk. In FIG. 1a, ultrasonic exciter 2 is still inactive.

FIG. 1b schematically indicates the beginning of the loading of the mixture of frothy milk and milk with ultrasound by ultrasonic exciter 2. FIG. 1c shows the result after an ultrasonic excitation of approximately 5 seconds. The result includes liquid, bubble-free milk 4 and a frothy milk 5 above it containing only a very slight amount of liquid milk are now located in the lower area of container 3. The formation of the boundary layer between milk 4 and froth 5 is especially important. If the boundary layer is clearly recognizable and does not include a large and thick boundary range, as a rule, the prerequisites are also met that during a subsequent addition of coffee the coffee settles on the boundary layer and practically does not mix at all with the liquid milk. Whereas on the other hand it simultaneously pushes the frothy milk floating on it upward, yielding as a whole the three different layers of liquid milk, coffee and frothy milk typical for a caffe latte macchiato.

A test series will now be described in the following that was carried out by the applicants in order to document the system in the loading of frothy milk with ultrasound. The first examination was to determine how long it takes until the milk completely settles in the frothy milk.

A latte macchiato was poured into a beaker glass in a coffee machine (in basic settings). The procedure was interrupted before the addition of coffee. The milk/frothy milk mixture was now placed in an ultrasonic bath. After 5 seconds of settling time the beaker glass was removed and measured where the boundary layer had formed between the milk and the frothy milk (height of the milk layer, see FIG. 2). This procedure was repeated, during which the time in the ultrasonic bath was raised to 10, 20, 40, and 80 seconds.

After five seconds in the ultrasonic bath, a boundary layer began to form between the milk and the frothy milk. This layer was just able to be detected visually. The longer the milk/frothy milk mixture was placed in the ultrasonic bath the more distinctly the boundary layer formed between the milk and the frothy milk. The height of the milk layer increased since more and more milk flowed from the frothy milk downward into the milk part. After a certain time in the ultrasonic bath, the height of the milk layer no longer increased since the milk and the frothy milk had completely separated. This maximal height of the milk layer was set at 100%.

In the associated diagram (FIG. 3), the time in the ultrasonic bath was recorded on the x-axis. The y-axis shows the height of the milk layer relative to the maximal height of the milk layer (complete separation of milk and frothy milk).

After 5 seconds in the ultrasonic bath, around one-third of the milk still remained in the frothy milk. After 10 seconds in the ultrasonic bath, the amount of milk in the frothy milk was still one-fourth of the total amount of milk, after 20 seconds still one-twentieth. After 40 seconds, the milk and the frothy milk had completely separated.

The complete separation of the milk/frothy milk mixture in the ultrasonic bath took 35 to 40 seconds. However, when making latte macchiato this process must not last longer than 5 to 10 seconds.

It is decisive for making a latte macchiato that a clear boundary layer is present between the milk and the frothy milk. This boundary layer also appears when the milk and the frothy milk have not yet been completely separated. After 5 seconds in the ultrasonic bath the boundary layer between milk and frothy milk was just able to be recognized, and after 10 seconds or more was already clearly formed. Therefore, it is assumed that 5 to 10 seconds in the ultrasonic bath are sufficient for forming a boundary layer that makes it possible to make a latte macchiato. This was examined more precisely in the following.

A check was made to see how long the milk/frothy milk mixture must be placed in the ultrasonic bath in order to subsequently obtain a clear boundary layer between milk and coffee.

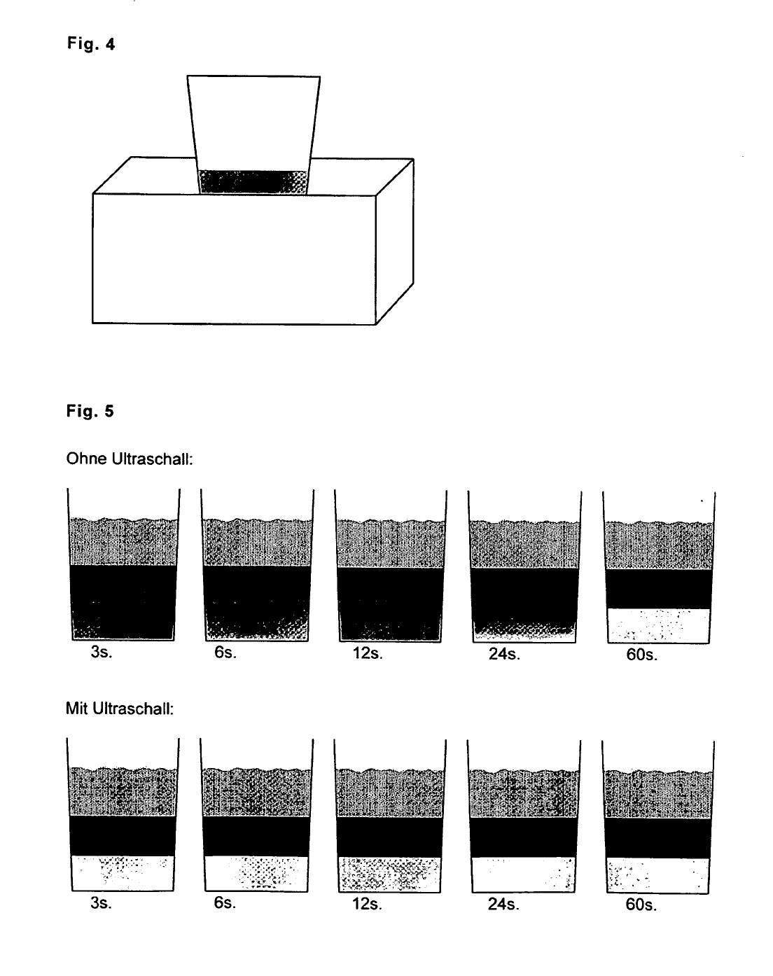

A latte macchiato was taken from the coffee machine (milk and frothy milk). The procedure was interrupted before the addition of coffee. The milk/frothy milk mixture was now allowed to stand for a set time. Settling times included 3, 6, 12, 24 and 60 seconds. Then the coffee was added. These tests were repeated. However, at this time, the milk/frothy milk mixture was placed in an ultrasonic bath (see FIG. 4), again for 3, 6, 12, 24 or 60 seconds. Then coffee was added. As a result, a comparison could be made whether the boundary layer between milk and coffee formed better when using ultrasound.

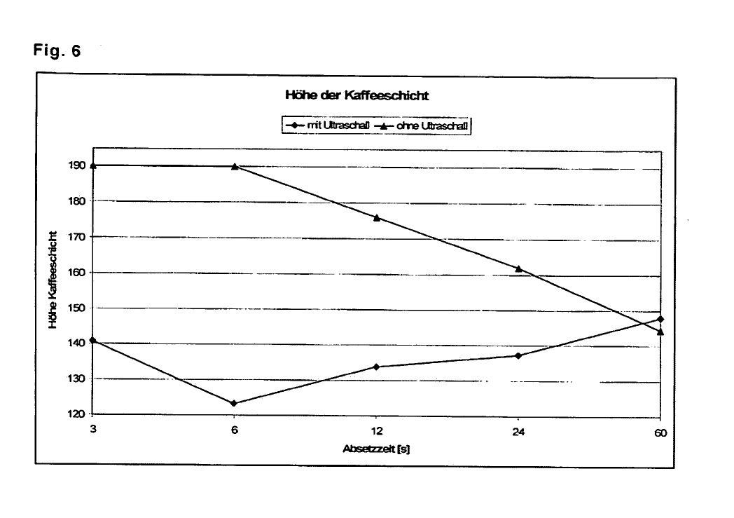

The illustrations in FIG. 5 clearly show that ultrasound clearly reduced the necessary settling time. Without ultrasound, a settling time of 60 seconds was necessary for obtaining a clear boundary layer between milk and coffee. With ultrasound, a clear boundary layer between milk and coffee was adjusted after three seconds in the ultrasonic bath.

The tests showed that the settling time can be clearly reduced by using ultrasound.

In sum, the present invention therefore makes possible a process and an apparatus for making latte macchiato coffee in less time than in traditional processes.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A process for making caffe latte macchiato from coffee, milk and frothy milk, comprising loading at least part of the frothy milk with oscillations in the ultrasonic range before the addition of coffee.

2. The process according to claim 1, wherein the oscillations are in a frequency range between 1 Hz and 1 GHz.

3. The process according to claim 1, wherein the oscillations are in a frequency range between 100 Hz and 100 kHz.

4. The process according to claim 1, wherein the loading of the frothy milk with oscillations takes place in a receiving container.

5. The process according to claim 4, wherein the receiving container is a drinking vessel.

6. The process according to claim 4, further comprising:
pouring the liquid milk and the frothy milk into a drinking vessel after the loading of the frothy milk with oscillations; and
supplying coffee to the drinking vessel.

7. The process according to claim 4, wherein the loading with oscillations in the receiving container takes place in a batch operation.

8. The process according to claim 4, wherein the loading with oscillations takes place in the receiving container in a continuous operation.

9. The process according to claim 1, wherein the loading with oscillations takes place between 0.5 seconds and 20 seconds.

10. The process according to claim 1, wherein the loading with oscillations takes place between 1 second and 6 seconds.

11. An apparatus for making caffe latte macchiato, comprising:
a coffee unit that is used to supply coffee;
a milk unit that is used to supply at least a frothy milk; and
a mechanism for loading the frothy milk with oscillations.

12. The apparatus according to claim 11, wherein the mechanism for loading the frothy milk with oscillations loads the frothy milk in the ultrasonic frequency range.

13. The apparatus according to claim 11, wherein the mechanism for loading the frothy milk with oscillations can be controlled so that the oscillations are in a range between 1 Hz and 1 GHz.

14. The apparatus according to claim 11, wherein the mechanism for loading the frothy milk with oscillations can be controlled so that the oscillations are in a range between 100 Hz and 100 kHz.

15. The apparatus according to claim 11, wherein the mechanism for loading the frothy milk with oscillations loads the frothy milk in a contactless manner.

16. The apparatus according to claim 11, wherein the mechanism for loading the frothy milk with oscillations is coupled to a container receiving the frothy milk.

17. The apparatus according to claim 11, wherein the mechanism for loading the frothy milk with oscillations comprises an ultrasonic bath.

18. The apparatus according to claim 11, wherein the mechanism for loading the frothy milk with oscillations comprises an ultrasonic exciter.

19. A process for making caffe latte macchiato, comprising:
supplying a coffee, a milk, and frothy milk; and
applying an ultrasonic exciter to at least part of the frothy milk before the addition of coffee.

20. The process of claim 19 wherein the ultrasonic exciter applies an ultrasonic oscillation in a frequency range between 1 Hz and 1 GHz, and wherein the applying the ultrasonic exciter takes place between 0.5 seconds and 20 seconds.
